(19) United States
(12) Patent Application Publication
(10) Pub. No.: US 2021/0253853 A1
(43) Pub. Date: Aug. 19, 2021

(54) POLYMERIC COMPOSITION, METHOD FOR PRODUCING A POLYMERIC COMPOSITION, SUBSTRATES COATED WITH A POLYMERIC COMPOSITION AND APPARATUS FOR COATING SUBSTRATES WITH A POLYMERIC COMPOSITION

(71) Applicant: Russell Bryan MORGAN, Turangi (NZ)

(72) Inventor: Russell Bryan MORGAN, Turangi (NZ)

(21) Appl. No.: 17/270,850

(22) PCT Filed: Aug. 23, 2018
(86) PCT No.: PCT/IB2018/056388

§ 371 Date: Feb. 23, 2021

(51) Int. Cl. C08L 71/14; C09D 171/14; B29C 44/34

(52) U.S. Cl. CPC C08L 71/14; B29K 2025/06; B29C 44/3461; C09D 171/14

(57) ABSTRACT

A polymeric composition with fire resistant properties is provided. The polymeric composition comprises a continuous phase and a disperse phase distributed in the continuous phase. The continuous phase is prepared by first mixing at least furfuryl alcohol with at least one first phenol, and by second adding a catalyst. The disperse phase comprises particles that are at least in parts heat-expandable. Furthermore, a method for producing such a polymeric composition, a substrate coated with such a fire resistant polymeric composition and an apparatus for machine-coating substrates with such a polymeric composition are provided.

The present invention is directed to a polymeric composition with fire resistant properties and a method for producing such a polymeric composition. Furthermore, the invention is directed to a substrate coated with such a fire resistant polymeric composition and to an apparatus for machine-coating substrates with a polymeric composition.

The mitigation of unwanted effects of potentially destructive fires, namely fire protection, plays an important role in the construction of new buildings and the renovation of old ones. Compliance with the most resent version of the building code is mandatory. Apart from escape routes, smoke detectors and so on, the focus is set on fire resistant building materials and means for preventing the extension of the fire in case of an incident, such as fire doors. However, fire protection is a costly matter. Consequently, there is a need for economic and effective means for fire protection, in particular for construction materials and their production.

For instance, from the international patent application PCT/AU02/00152 polymeric composite foams that can be used to produce fire resistant boards, in particular steel-clad insulation panels having a core of a polymeric composition foam comprising a continuous phase of a furan polymer or phenolic and furan polymer and a disperse phase of foamed polystyrene polymer, are known. In order to produce such polymeric composition foam, 5-50% w/w of foamable unexpanded polystyrene beads, 50-95% w/w of a resin or resin mix selected from the group of a furan resin, a phenolic resin and furan resin, and a phenolic resin and furfuryl alcohol and an effective amount of an acid catalyst are reacted without applying an external heat or energy source.

In the U.S. Pat. No. 5,531,849 an apparatus for manufacturing padding for underlying a carpet floor covering and a method for manufacturing such a padding are described. The apparatus has a frame to which a first conveyor belt is mounted for feeding a first liner sheet along a conveyor path from a forward end to a rearward end. A foam spray assembly is connected to an uncured polymeric foam supply and has a spray nozzle mounted adjacent to the forward end of the conveyor path. The spray nozzle dispenses uncured, resilient polymeric foam as a generally uniform layer on the surface of the first liner sheet as it is moved along the conveyor path. A second conveyor belt is also mounted to the frame and is located along the conveyor path and spaced apart a selected vertical distance from the first conveyor belt. The second conveyor belt is parallel to the first conveyor belt and feeds a second liner sheet along the conveyor path parallel to the first liner sheet so that the second liner sheet is positioned over the layer of foam as it is moved along the conveyor path. Movement of the first and second liner sheets and dispensed foam along the conveyor path forms a sandwiched layer of foam material with the first and second conveyor belts compressing the sandwiched layer of foam material to a selected thickness as it is moved along the conveyor path. A heat cover surrounds the first and second conveyor belts and is connected to heat source, such as a heated air supply for introducing heated air within the heat cover. The method for manufacturing involves the step of depositing an amount of uncured, resilient polymeric foam material over a liner sheet or layer of padding material so that the foam material is uniformly deposited over the liner sheet or layer of padding material. The polymeric foam material both applied by the foam spray assembly of the apparatus and used for manufacturing the padding is a polyurethane foam formed by the reaction of polyols with di- or poly-isocyanates. These components are metered by means of the metering equipment being part of the apparatus to produce a high resiliency, open cell polyurethane foam.

The object of the present invention is the provision of means enabling the production of building materials having fire resistant properties. An aspect of the invention is also the provision of a method for manufacturing such means. A further aspect of the invention is the provision of a method and an apparatus for producing such building materials.

This object is achieved by a polymeric composition according to claim 1.

Such a polymeric composition comprises a continuous phase and a disperse phase. The continuous phase is prepared by first mixing, preferably mixing and heating, at least furfuryl alcohol with at least one first phenol, and by second adding a catalyst. The disperse phase comprises particles that are at least in parts heat-expandable. The disperse phase and thus the heat-expandable particles are distributed in the continuous phase.

In one embodiment of the polymeric composition according to the invention, which may be combined with any of the embodiments still to be addressed unless in contradiction, the continuous phase is prepared by first mixing, preferably mixing and heating, at least furfuryl alcohol with at least one first phenol, and by second adding at least one second phenol and a catalyst.

In one embodiment of the polymeric composition according to the invention, which may be combined with any of the preaddressed embodiments and any of the embodiments still to be addressed unless in contradiction, said at least one first phenol and/or said at least one second phenol comprises tannin, preferably at least in parts tannin as particulate solid.

In another aspect of the invention a method for producing a polymeric composition is provided. The method comprises, preferably performed as a first step, the mixing, or preferably the mixing and heating, of at least furfuryl alcohol and at least one first phenol. In a further step, preferably performed after mixing and heating, particles that are at least in parts heat-expandable are added to the mixture. In an even further step, preferably performed after adding the particles, a catalyst is added to the mixture for initiating a polymerisation reaction.

For instance, the first phenol can be phenol or a poly-phenol, such as di-phenol, tri-phenol or tannin. The first phenol and the furfuryl alcohol can, e.g., be mixed in a weight ratio of 1:1. In general it is beneficial to use between 20-50% w/w of furfuryl alcohol and between 10-50% w/w of the first phenol. In particular between 25-40% w/w of furfuryl alcohol and between 15-35% w/w of the first phenol are preferred.

In one embodiment of the method according to the invention, which may be combined with any of the preaddressed embodiments and any of the embodiments still to be addressed unless in contradiction, the method comprises adding at least one second phenol to the mixture before adding the catalyst.

The second phenol can be phenol itself or a poly-phenol, such as di-phenol, tri-phenol or tannin, or a condensation product between a phenol (phenol itself or poly-phenol) and formaldehyde. The at least one second phenol can be added to the mixture of at least furfuryl alcohol and the at least one first phenol, preferably after the furfuryl alcohol and the first phenol have been mixed and heated. Preferably performed after adding the at least one second phenol, the particles and the catalyst are added. The second phenol is for instance added in an amount of 20-40% w/w. Instead or in addition to the second phenol, one or more additives can be added. Such additives can comprise neutralizers, e.g. for the catalyst or rather in order to neutralize the whole polymeric composition to prevent corrosion of materials (e.g. steel) coming into contact with the polymeric composition, additives that increase the generated heat (e.g. hydrogen peroxide), fire retardants (e.g. comprising chlorine, bromine, boron, phosphorous or ammonia especially ammonium phosphate, or expandable graphite), intumescent additives (e.g. e.g. a mixture of melamine, a PVA co-polymer, pentaerythritol and ammonium phosphate), fillers (e.g. perlite, fly ash, and vermiculite), surfactants, polymerization profile adjusters (e.g. urea, formaldehyde, and glyoxal) and so on.

The resin composition describes the mixture without the heat-expandable particles. The amounts of furfuryl alcohol, the first phenol(s), the second phenol(s), the optional additive(s) and the catalyst in the resin composition sum up to 100%. The amounts of furfuryl alcohol, the first phenol(s) and the second phenol(s) mentioned so far refer to the resin composition without the heat-expandable particles. The actual polymeric composition comprises in addition the particles that are at least in parts heat-expandable. In the polymeric composition the resin composition makes up between 50-90% w/w and the particles make up between 10-50% w/w. The density of the unexpanded polymeric composition is about 1000-1300 kg/m³, after expansion about 30-150 kg/m³.

In one embodiment of the method according to the invention, which may be combined with any of the preaddressed embodiments and any of the embodiments still to be addressed unless in contradiction, the at least one phenol and/or the at least second phenol comprises tannin. In a preferred embodiment, the tannin is at least in parts provided as particulate solid.

Most of the educts or even all educts that are used for producing the resin composition are present in liquid form (under standard temperature and pressure). However, if tannin is used as first and/or second phenol, there is also a solid present.

In one embodiment of the method according to the invention, which may be combined with any of the preaddressed embodiments and any of the embodiments still to be addressed unless in contradiction, the method comprises adding a first additive for neutralization of the catalyst and/or the step of curing the mixture after adding the catalyst.

The first additive for neutralization of the catalyst can be any neutralizer helping to bring the pH value of the mixture from an acidic value closer to 7. The first additive can therefore be an alkaline material that dissolves slowly in the resin composition, such as calcium carbonate or anhydrous borax. It is preferable to add a neutralizing additive to avoid the final cured polymeric composition being highly acidic, which may induce corrosion if in contact with metal surfaces in the presence of water. The addition of the neutralizer can be performed before or after the catalyst is added, wherein an addition before is preferred. The curing of the mixture after the addition of the catalyst can include the application of radiation, heat or air, or just a certain waiting time or any combination thereof.

In one embodiment of the method according to the invention, which may be combined with any of the preaddressed embodiments and any of the embodiments still to be addressed unless in contradiction, the step of mixing, or preferably mixing and heating, at least furfuryl alcohol and the at least one first phenol lasts between 1 to 15 hours.

In order to gain a well-mixed mixture (of at least furfuryl alcohol and the at least one first phenol), it is beneficial to choose a not too short mixing time. The most beneficial mixing time also depends, e.g., on the type and amount of the first phenol(s), the amount of furfuryl alcohol, and the optional presence and choice of additives.

A preferred mixing time can be between 5-10 hours, but also between 7-13 hours, or 9-11 hours. The mixing can, e.g., be performed at 3000 to 5000 rpm with elevated shear.

In one embodiment of the method according to the invention, which may be combined with any of the preaddressed embodiments and any of the embodiments still to be addressed unless in contradiction, the step of heating the mixture comprises heating the mixture to between 60° C. and 150° C.

Heat supply is beneficial e.g. from friction while mixing or a heated jacket on the mixing vessel. In particular temperatures between 60° C. and 150° C., between 80° C. and 100° C. and of about 90° C. are preferred.

For instance, in the step of mixing, or preferably mixing and heating, at least furfuryl alcohol and at least one first phenol, tannin in solid form can be used as the first phenol or as one of the first phenols. In one example, a mixture of furfuryl alcohol and tannin in the form of particulate solid is mixed and, at the same time or thereafter, is heated to between 60° C. and 150° C.

In one embodiment of the method according to the invention, which may be combined with any of the preaddressed embodiments and any of the embodiments still to be addressed unless in contradiction, the catalyst is an acidic catalyst, preferably with a pKₐ≤3.

Such an acidic catalyst can be a strong inorganic acid, such as HCl, H₃PO₄, H₂SO₄, or a strong organic acid, such as phenolsulfonic acid. It is preferred that the catalyst makes up 10-30% w/w of the resin composition.

In one embodiment of the method according to the invention, which may be combined with any of the preaddressed embodiments and any of the embodiments still to be addressed unless in contradiction, the heat-expandable particles comprise heat-expandable polystyrene beads.

For example, beads used in commercial production of EPS (expanded polystyrene) foam may be used. Such beads generally contain pentane as blowing agent, and have a particle size between about 0.4 mm and about 2 mm.

An aspect of the invention relates to a polymeric composition comprising a continuous phase and a disperse phase. The continuous phase is prepared by first mixing, preferably mixing and heating, at least furfuryl alcohol with at least one first phenol and by second adding a catalyst. Optionally at least one second phenol can be added before adding the catalyst. The disperse phase is distributed in the continuous phase and comprises particles being at least in parts heat-expandable.

A further aspect of the invention relates to the use of a polymeric composition produced according to a method according to the invention for producing a polymeric composition as a coating. Another further aspect relates to the use of a polymeric composition according to the invention as a coating.

A polymeric composition as direct product of a method according to the invention for producing a polymeric composition or a polymeric composition according to the invention can be applied as coating and as such be deposited on a substrate. The coating may be applied directly onto a plate, a board or the like, or can be deposited onto a film or foil (e.g. polyethylene plastic, glass tissue, paper, cardboard or aluminium foil). The coated film or foil can later, e.g., be attached to a plate, board or the like. The use of the polymeric composition as a coating is in particular beneficial to produce fire resistant building materials, such as boards being either coated directly or covered with a coated film or foil. When exposed to fire, the polymeric composition will not flame but instead turn to a black char, without spreading fire.

A further aspect of the invention relates to a product that is coated with a polymeric composition according to the invention or that is coated with a polymeric composition produced according to a method according to the invention for producing a polymeric composition.

Such a coated product shows improved fire resistant properties compared to the uncoated product. Such a product can, e.g., be a board, a film or a foil.

In one embodiment of the product according to the invention, which may be combined with any of the preaddressed embodiments and any of the embodiments still to be addressed unless in contradiction, the thickness of the unexpanded coating lies between 2 to 20 mm.

As soon as the heat-expandable particles expand, the initial thickness and therefore the originally laid down thickness of the coating enhances. For instance, a coating initial applied with a thickness of 2 to 20 mm may reach a final and therefore expanded thickness of 20 to 250 mm.

A further aspect of the invention relates to a fire resistant board comprising a continuous phase comprising furfuryl alcohol and at least one first phenol and a disperse phase comprising particles being at least in parts heat-expandable.

In an example, the continuous phase comprises additionally a second phenol. In another example, the fire resistant board is a foam board made of an expanded polymeric composition according to the invention, the expanded polymeric composition comprising a continuous phase and a disperse phase as described above. Said foam board can be sandwiched between, e.g., foils or films, such as polyethylene films. In order to manufacture such boards, the coating as previously described is applied on a first foil or film and contacts due to the expansion a second foil or film, such that the expanded coating gets sandwiched between said first and said second foil. Such a foam board has, e.g., a thickness of about 50-200 mm, a width of about 1.2 m and a length of about 2.4-3 m.

A further aspect of the invention relates to a method for machine-coating a substrate with a polymeric composition according to the invention. The method comprises the steps of providing a substrate, providing an uncured polymeric composition, feeding the substrate along a conveyor path, depositing an amount of uncured polymeric material on the product, and allowing the deposited uncured polymeric material to at least partially cure.

The substrate can, e.g., be a film or a foil, which is unwound from a supply roll. Said substrate is transported along a conveyor path, e.g., by a conveyor belt. A mixer that is fed with a suspension of a resin composition and of heat-expandable particles and also with a catalyst provides an uncured polymeric composition. By, e.g., means of a coating head the uncured polymeric composition is applied to the substrate. The laid down coating is allowed to cure along the further path of the conveyor path. Curing may also comprise heat-initiated expanding of the coating and of the heat-expandable particles, respectively. The step of providing an uncured polymeric composition can comprise a method for producing a polymeric composition according to the invention.

In one example of the method according to the invention, which may be combined with any of the preaddressed embodiments and any of the embodiments still to be addressed unless in contradiction, the step of providing an uncured polymeric composition comprises (i) mixing at least furfuryl alcohol and at least one first phenol and heating the mixture of the furfuryl alcohol and the at least one first phenol. Afterwards, said mixture can be filled in a storage tank, e.g., of an apparatus for machine-coating. Furthermore, the step of providing an uncured polymeric composition can comprise (ii) adding particles that are at least in parts heat-expandable and/or (iii) adding a catalyst. Optionally, at least one second phenol and/or at least one additive can be added. The particles, the catalyst, the second phenol(s) and the additive(s) can also be filled in a storage tank or hopper (for solids), e.g., of an apparatus for machine-coating.

In one example of the method according to the invention, which may be combined with any of the preaddressed embodiments and any of the embodiments still to be addressed unless in contradiction, the step of depositing an amount of uncured polymeric material comprises at least one of wide slit extruding, of knife coating, of edge coating, of cascade coating and of spraying.

A further aspect of the invention relates to an apparatus for machine-coating. Such an apparatus comprises a first conveyer for transporting a substrate. The first conveyor moving in a transportation direction and thus having a transportation direction. Furthermore, the apparatus comprises a coating head that is directed to the first conveyer. The coating head is for depositing a polymeric composition on the substrate that is transported by the first conveyer. Moreover, the apparatus comprises a mixer for providing the polymeric composition. In said mixer a resin composition without catalyst, particles being at least in parts heat-expandable and a catalyst are mixed. The mixer is in fluid-connection with the coating head to supply the coating head with the polymeric composition for coating. The mixer is also in fluid-connection with a first storage tank for the resin composition without catalyst, with a second storage tank for the catalyst and with a storage vessel, e.g. a hopper, for the particles being at least in parts heat expandable. The resin composition without catalyst can either be ready prepared elsewhere and just filled into the first storage tank, or the apparatus can comprise in addition or instead means for providing such a resin composition. Such a means can, e.g., be a temperature regulatable vessel equipped with a mixer for mixing and heating at least furfuryl alcohol and the first phenol(s) and optionally the second phenol, when applicable. These educts can be added manually or by means of additional storage tanks. The first storage vessel is therefore not just limited to a literal storage device but also includes instead or in addition means for providing the resin composition without catalyst. To initiate the heat-expansion of the particles, a heat source is also present in the apparatus. Last but not least, the apparatus comprises a second conveyer. Said second conveyer is arranged in parallel to the first conveyer and also, at least in parts, arranged above the first conveyer. The second conveyor is arranged such that the deposition the polymeric composition is not disturbed. Between the first and the second conveyer is a distance and said distance is big enough to allow the polymeric composition already deposited by the coating head on the substrate to at least partially expand and thus rise.

The first conveyer may be a band either covered with Teflon or made entirely of Teflon or a flexible metal construction, which transports the substrate. A substrate may be a film or a foil onto which the coating is laid down, but it may also be a board, e.g. made of wood or polymer that shall be coated. The coating head can comprise, e.g., a spray head that is mounted on a reciprocating traverse, which is movable perpendicular to the moving direction of the first conveyer. The coating head can, e.g., be mounted on a carrier, which is moving forth and back in a direction perpendicular to the transportation direction of the substrate. However, not solely the coating head but also a coating unit comprising the coating head, a mixer for mixing the suspension with the catalyst, and a catalyst reservoir can be arranged on a carrier movable as described above. The mixer can, e.g., comprise or be a static mixer in operative connection with reservoirs comprising the substances required for producing the polymeric composition. For instance, the mixer can be operatively connected via a metering unit to a reservoir comprising a suspension of a polymeric resin and of heat-expandable particles and can also be operatively connected via a metering unit to a reservoir comprising the catalyst. The polymerisation is then initiated my mixing the suspension and the catalyst in the mixer. Therefore, it is advantageous to arrange the mixer in close vicinity to the coating head, e.g. by mounting the mixer above the coating head. It is also advantageous to form a coating unit comprising a coating head, a suspension reservoir and a catalyst reservoir. Such a suspension reservoir may comprise a mixing device itself to actually produce the suspension of resin composition and particles. In order to produce the suspension, an adapter can be used to admix online solid particulate matter, namely the heat-expandable particles, into the fluid flow of the resin composition without catalyst. Such an adapter may comprise a centrifugal pump and/or a single screw extruder. The hose that is actually connecting the mixer and the reservoir comprising the suspension should comprise an even inner wall free of constrictions, sharp bends, curvatures and the like and might preferably comprise a radius of 1 m. The metering units provide both for the dosage and the transport of the substances. E.g., for the transportation and dosage of liquids a metering pump may represent the metering unit. For solids (e.g. tannin as solid particles, heat-expandable particles, neutralizer additives . . . ), on the other hand, powder extruders comprising, e.g., Archimedes spirals may be an option. However, the mixer can also be operatively connected to a first and a second reservoir via a first and a respective second metering unit. For instance, a heat source for initiating and/or accelerating the curing of the polymeric composition can be a radiation heating or a ventilator blowing warm air. The second conveyer may be designed in the same manner as the first conveyer. The parallel arrangement of the two conveyers enable for a homogenous height of the coating. In case the unexpanded coating has a thickness of about 2-20 mm, the expanded coating will have a thickness of about 20-250 mm. A preferred distance between the two conveyers is thus about 20-250 mm. The heat source is preferably arranged somewhere along the conveyor path where the second conveyor is already arranged above the first conveyor. The first conveyor can transport the fully expanded and cured substrate further, for example to a packaging station. The sides left and right (so parallel to the transportation direction) of the distance between the two conveyors may be bordered by either static boards or by films transported by the same mechanism as the conveyors are moved.

The invention shall by further exemplified by three explicit examples.

### EXAMPLE 1

This example illustrates a polymeric composition that incorporates furfuryl alcohol plus a first phenol.

In a 180 L volume steel vessel, with a hot/cold water jacket and shear disc variable speed mixer set at 3000 rpm, 50 kg furfuryl alcohol was mixed with 25 kg mimosa tannin powder (grade Bondtite 945 ex Bondtite (Pty) Ltd, Pietermaritzburg, South Africa).

The mix was heated to 90° C. and held at this temperature (tolerance of ±2° C. acceptable) for 6 hours, with a reduced mixer speed of 2000 rpm to avoid further temperature increase. The mix was then cooled to 40° C. via addition of 10 kg water, and ambient temperature water in the heating/cooling jacket on the mixing vessel. The mix was transferred to the first storage tank for the resin composition on an apparatus for machine-coating (double belt conveyor).

The said first storage tank was connected via a hose to a static mixer head mounted on a traverse above the first conveyor on the apparatus.

A pump was delivering the resin composition (not comprising any catalyst or additive, such as neutralizer, yet) the mixer head at a flow rate of 3.08 kg/min. To this resin composition flow was added, from a first hopper, via an Archimedes spiral, a first additive, at a flow rate of 0.26 kg/min. This additive was a neutralizer in the form of particulate calcium carbonate (particle size 0.5-1.0 mm, grade Omyacal 16/30, ex Omya New Zealand Ltd}.

At the same time, from a second hopper, via an Archimedes spiral, expandable particles were added to the resin composition flow. The particles were expandable polystyrene beads, grade Styropor KF 212 ex BASF (particle size 1-1.4 mm). The flow rate of the expandable particles was 2.0 kg/min.

From a separate second storage tank, an acid catalyst, being 65% phenolsulfonic acid, was metered via a pump and hose to the static mixer head on the apparatus. The flow rate of the catalyst was 0.62 kg/min.

The final mixture of all the chemical components, constituting the polymeric composition, was deposited via a spray nozzle fitted to the static mixer, onto a moving polyethylene film on the first conveyor of the apparatus. Conveyor speed was 0.7 m/min, traverse speed 1 m/second (perpendicular to conveyor direction) and the distance between the first and second conveyor 100 mm. A second polyethylene film was covering the underside of the second conveyor, and moving with the conveyor, at the same speed as the first conveyor.

An expanded polymeric composition emerged from the apparatus, in the form of a rigid foam board, lined on both sides with polyethylene films. Thickness of the product was 100 mm, and width 1200 mm. The product was cut to length of 2.4 m, for use as thermal insulation board. The density of the product was 69 kg/m³.

When exposed to a fire (gas torch), the product would not flame but instead turn to a black char without spreading the flame.

### EXAMPLE 2

This example illustrates a polymeric composition that incorporates furfuryl alcohol plus a first phenol plus a second phenol.

In a 180 L volume steel vessel, with a hot/cold water jacket and shear disc variable speed mixer set at 3000 rpm, 70 kg furfuryl alcohol was mixed with 25 kg mimosa tannin powder (grade Bondtite 945 ex Bondtite (Pty) Ltd, Pietermaritzburg, South Africa).

The mix was heated to 85° C. and held at this temperature (tolerance of ±2° C. acceptable) for 10 hours, with a reduced mixer speed of 2000 rpm to avoid further temperature increase. The mix was then cooled to 40° C. via cooling water in the heating/cooling jacket on the mixing vessel. A second phenol was then added, being a liquid phenol-formaldehyde resin, grade Prefere 72 5648L. The weight of this resin was 40 kg. After 10 minutes mixing, the mix was transferred to the first storage tank for the resin composition on an apparatus for machine-coating (double belt conveyor).

The said first storage tank was connected via a hose to a static mixer head mounted on a traverse above the first conveyor on the apparatus.

A pump was delivering the resin composition (not comprising any catalyst or additive, such as neutralizer, yet) to the mixer head at a flow rate of 3.08 kg/min. To this resin composition flow was added, from a first hopper, via an Archimedes spiral, a first additive, at a flow rate of 0.26 kg/min. This additive was a neutralizer in the form of particulate calcium carbonate (particle size 0.5-1.0 mm, grade Omyacal 16/30, ex Omya New Zealand Ltd}.

At the same time, from a second hopper, via an Archimedes spiral, expandable particles were added to the resin composition flow. The particles were expandable polystyrene beads, grade Styropor KF 212 ex BASF (particle size 1-1.4 mm). The flow rate of the expandable particles was 1.8 kg/min.

From a separate second storage tank, an acid catalyst, being 85% phosphoric acid, was metered via a pump and hose to the static mixer head on the apparatus. The flow rate of the catalyst was 0.68 kg/min.

The final mixture of all the chemical components, constituting the polymeric composition, was deposited via a spray nozzle fitted to the static mixer, onto a moving polyethylene film on a first conveyor of the apparatus. Conveyor speed was 0.78 m/min, traverse speed 1 m/second (perpendicular to conveyor direction) and the distance between the first and second conveyor 100 mm. A second polyethylene film was covering the underside of the second conveyor, and moving with the conveyor, at the same speed as the first conveyor.

An expanded polymeric composition emerged from the apparatus, in the form of a rigid foam board, lined on both sides with polyethylene films. Thickness of the product was 100 mm, and width 1200 mm. The product was cut to length of 2.4 m, for use as thermal insulation board. The density of the product was 56 kg/m³.

When exposed to a fire (gas torch), the product would not flame but instead turn to a black char without spreading the flame.

### EXAMPLE 3

This example illustrates a polymeric composition that incorporates furfuryl alcohol plus a first phenol plus a second phenol.

In a 180 L volume steel vessel, with a hot/cold water jacket and shear disc variable speed mixer set at 3000 rpm, 50 kg furfuryl alcohol was mixed with 50 kg mimosa tannin powder (grade Bondtite 945 ex Bondtite (Pty) Ltd, Pietermaritzburg, South Africa).

The mix was heated to 90° C. and held at this temperature (tolerance of ±2° C. acceptable) for 1 hour, with a reduced mixer speed of 2000 rpm to avoid further temperature increase. Water was then added, with a weight of 16 kg, and the mix cooled to 40° C. via cooling water in the heating/cooling jacket on the mixing vessel. A second phenol was then added, being a phenol-formaldehyde resin, grade Prefere 91 5701Lx. The weight of this resin was 30 kg. After 10 minutes mixing, the mix was transferred to the first storage tank for the resin composition on an apparatus for machine-coating (double belt conveyor).

The said first storage tank was connected via a hose to a static mixer head mounted on a traverse above the first conveyor on the apparatus.

A pump was delivering the resin composition (not comprising any catalyst or additive, such as neutralizer, yet) to the mixer head at a flow rate of 3.08 kg/min. To this resin composition flow was added, from a first hopper, via an Archimedes spiral, a first additive, at a flow rate of 0.26 kg/min. This additive was a neutralizer in the form of particulate calcium carbonate (particle size 0.5-1.0 mm, grade Omyacal 16/30, ex Omya New Zealand Ltd}.

At the same time, from a second hopper, via an Archimedes spiral, expandable particles were added to the resin composition flow. The particles were expandable polystyrene beads, grade Styropor KF 212 ex BASF (particle size 1-1.4 mm). The flow rate of the expandable particles was 1.8 kg/min.

From a separate second storage tank, an acid catalyst, being 65% phenolsulfonic acid, was metered via a pump and hose to the static mixer head on the apparatus. The flow rate of the catalyst was 0.68 kg/min.

The final mixture of all the chemical components, constituting the polymeric composition, was deposited via a spray nozzle fitted to the static mixer, onto a moving polyethylene film on a first conveyor of the apparatus. Conveyor speed was 0.7 m/min, traverse speed 1 m/second (perpendicular to conveyor direction) and the distance between the first and second conveyor 100 mm. A second polyethylene film was covering the underside of the second conveyor, and moving with the conveyor, at the same speed as the first conveyor.

An expanded polymeric composition emerged from the apparatus, in the form of a rigid foam board, lined on both sides with polyethylene films. Thickness of the product was 100 mm, and width 1200 mm. The product was cut to length of 2.4 m, for use as thermal insulation board. The density of the product was 65 kg/m³.

When exposed to a fire (gas torch), the product would not flame but instead turn to a black char without spreading the flame.

The invention shall now be further exemplified with the help of figures. The figures show:

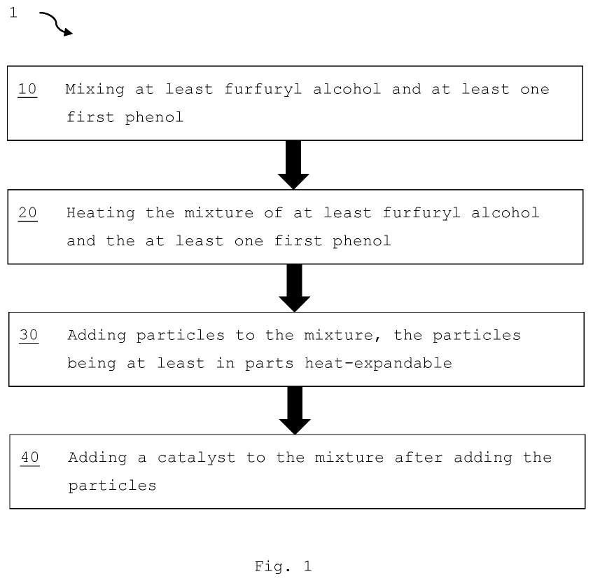

FIG. 1 a flow chart of a method according to the invention for producing a polymeric composition;

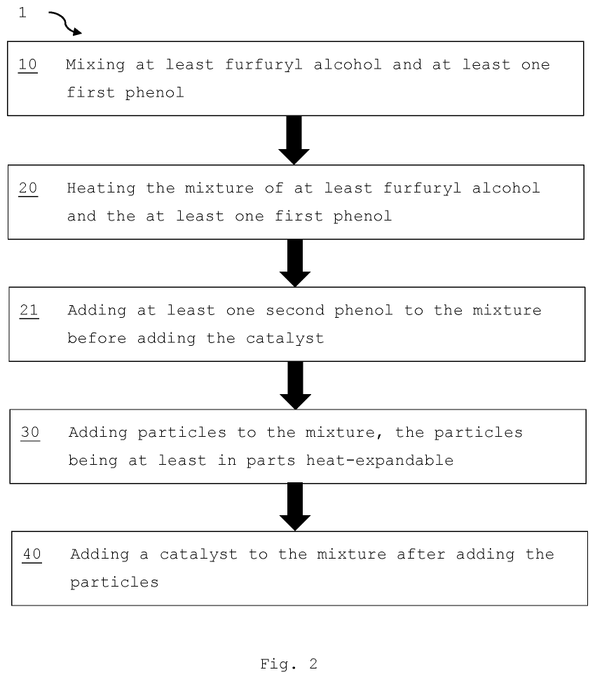

FIG. 2 a flow chart of an embodiment of the method according to the invention for producing a polymeric composition;

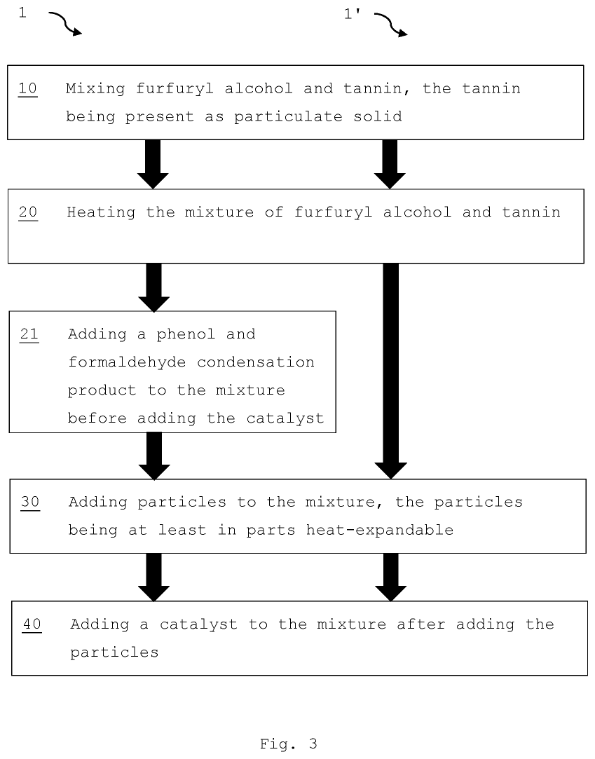

FIG. 3 a flow chart of another embodiment of the method according to the invention for producing a polymeric composition;

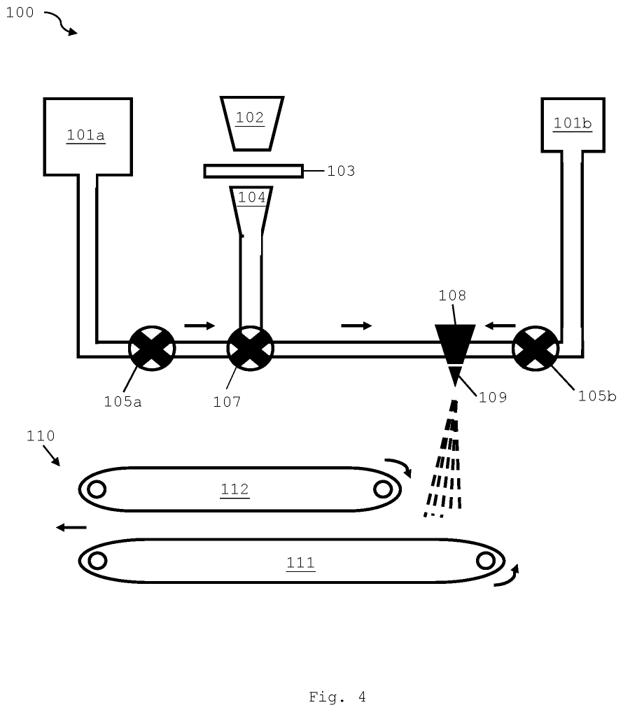

FIG. 4 a schematic view of an apparatus according to the invention for machine-coating.

FIG. 1 shows a flow chart visualising the single steps of one embodiment of a method for producing a polymeric composition. The method 1 starts with mixing at least furfuryl alcohol and at least one first phenol 10, followed by heating the mixture of at least furfuryl alcohol and the at least one first phenol 20. Thereafter, particles are added to the mixture that are at least in parts heat-expandable 30. In a last step, a catalyst is added to the mixture 40.

FIG. 2 shows a flow chart visualising the single steps of another embodiment of a method for producing a polymeric composition. The method 1 described here is in general similar to the method described by means of FIG. 1, however, it comprises a further step. After the steps mixing at least furfuryl alcohol and at least one first phenol 10 and heating the mixture of at least furfuryl alcohol and the at least one first phenol 20 are completed, at least one second phenol is added to the mixture 21 before particles are added to the mixture that are at least in parts heat-expandable 30 and before a catalyst is added to the mixture 40.

FIG. 3 shows a flow chart that is visualising two embodiments of a method for producing a polymeric composition. The first embodiment 1′ is comparable to the embodiment described by means of FIG. 2 and the second embodiment 1′ is comparable to the embodiment described by means of FIG. 1. However, the steps 10, 20 and 21 are more specified. Both embodiments 1, 1′ comprise mixing furfuryl alcohol and tannin, the tannin being present as particulate solid 10 and heating the mixture of furfuryl alcohol and tannin 20. Embodiment 1 further comprises adding a phenol and formaldehyde condensation product to the mixture before adding the catalyst 21.

FIG. 4 shows a schematic view of an apparatus 100 for machine-coating according to the invention. The shown apparatus 100 comprises two storage tanks; one storage tank 101a for a resin composition without catalyst (e.g. based on a first phenol and furfuryl alcohol or on a first phenol, furfuryl alcohol and a second phenol) and one storage tank 101b for the catalyst. The fluids, in this embodiment namely the resin and the catalyst, are provided by means of metering pumps 105a, 105b. Furthermore, the apparatus 100 comprises a hopper 102 for the solid heat expandable particles. However, it is also possible that the hopper 102 provides in addition for a neutralizer additive or the like. The heat expandable particles first pass a slotted rod 103 before they are added by means of a chute 104. A pressuring pump 107 is receiving the particles from the chute 104 and provides for their transportation. On the one hand, the heat-expandable particles are added to the resin and led to a mixer 108. On the other hand, the catalyst is provided by means of the metering pump 105b and is also led to the mixer 108. In the mixer 108 the catalyst is mixed with the premix of resin composition without catalyst and heat expandable particles. The final mixture, i.e. the uncured polymeric composition, is applied on a substrate (not shown), e.g. by means of a coating head 109 directed to a first conveyer 111, being part of a double belt conveyor 110 and providing a substrate. The mixer 108 is, e.g., in fluid-connection with the coating head 109. A second conveyer 112 is arranged in parallel above the first conveyer 111 and is also part of the double belt conveyor 110. After application, the polymeric composition can cure on the substrate between the first and second conveyor 111, 112. The second conveyer 112 is not arranged above the first conveyor 111 along the full length of the first conveyer 111. The second conveyer 112 is arranged after the coating head 109. The second conveyor 112 can also end before the first conveyer 111 does (viewed in transportation direction). The heat source initiating the expansion is not shown. The second conveyor 112 supplies a second substrate, such that the polymeric composition can cure between the first and the second substrate. When a neutralizer shall be added, the apparatus may comprise an additional storage vessel, for the neutralizer such as an additional hopper, the neutralizer being added before the mixer 108 and after the first storage tank 101a. The arrows in the scheme indicate on the one hand the moving direction of the components (resin, heat expandable particles, catalyst) of the polymeric composition and on the other hand the moving direction of the conveyors 111, 112 and the transportation direction of the substrate.

Reference sign

| | |
|---|---|
| 1 | Method |
| 10 | Mixing at least furfuryl alcohol and at |
| | least one first phenol |
| 20 | Heating the mixture of at least |
| | furfuryl alcohol and the at least one |
| | first phenol |
| 21 | Adding at least one second phenol to |
| | the mixture before adding the catalyst |
| 30 | Adding particles to the mixture, the |
| | particles being at least in parts heat- |
| | expandable |
| 40 | Adding a catalyst to the mixture after |
| | adding the particles |
| 100 | Apparatus |
| 101a, 101b | Storage tank |
| 102 | hopper |
| 103 | Slotted rod |
| 104 | Chute |
| 105a, 105b | Metering pump |
| 107 | Pressurising Pump |
| 108 | Mixer |
| 109 | Coating head |
| 110 | Double belt conveyor |
| 111 | First conveyor |
| 112 | Second conveyor |

1. Polymeric composition comprising a continuous phase and a disperse phase, wherein the continuous phase is prepared by first mixing, preferably mixing and heating, at least furfuryl alcohol with at least one first phenol, and by second adding a catalyst, and wherein the disperse phase comprises particles being at least in parts heat-expandable and distributed in the continuous phase.

2. Polymeric composition according to claim 1, wherein the continuous phase is prepared by adding at least one second phenol before adding said catalyst.

3. Polymeric composition according to claim 1, wherein said at least one first phenol and/or said at least one second phenol comprises tannin, preferably at least in parts tannin as particulate solid.

4. Method for producing a polymeric composition comprising:
Mixing, preferably mixing and heating, at least furfuryl alcohol and at least one first phenol;
Adding particles to the mixture, the particles being at least in parts heat-expandable;
Adding a catalyst to the mixture after adding the particles.

5. Method according to claim 4, further comprising:
Adding at least one second phenol to the mixture before adding the catalyst.

6. Method according to claim 4, wherein said at least one first phenol and/or said at least one second phenol comprises tannin, preferably at least in parts tannin as particulate solid.

7. Method according to claim 4, further comprising:
Adding a first additive for neutralizing the catalyst.

8. Method according to claim 4, wherein mixing at least furfuryl alcohol and at least one first phenol lasts between 1 to 15 hours.

9. Method according to claim 4, wherein heating the mixture comprises at least one of heating the mixture to between 60° C. and 150° C.

10. Method according to claim 4, wherein the catalyst is an acidic catalyst, preferably with a pKₐ≤3.

11. Method according to claim 4, wherein the particles comprise heat-expandable polystyrene beads.

12. Use of a polymeric composition according to claim 1 as coating.

13. Product coated with a polymeric composition according to claim 1.

14. Product according to claim 13, wherein the thickness of the unexpanded coating lies between 2 to 20 mm and/or wherein the thickness of the expanded coating lies between 20 to 250 mm.

15. Fire resistant board comprising a continuous phase and a disperse phase, the continuous phase comprising either furfuryl alcohol and a first phenol or furfuryl alcohol, a first phenol and a second phenol, the disperse phase comprising particles being at least in parts heat-expandable, wherein the first and/or the second phenol preferably comprises tannin, further preferably at least in parts tannin as particulate solid.

16. Method for machine-coating a substrate with a polymeric composition, the method comprising:
providing a substrate;
providing an uncured polymeric composition according to claim 1;
feeding the substrate along a conveyor path;
depositing an amount of uncured polymeric material on the substrate;
allowing the deposited uncured polymeric material to at least partially cure.

17. Apparatus (100) for machine-coating comprising:
a first conveyer (111) for transporting a substrate, the first conveyer (111) having a transportation direction;
a coating head (109) directed to the first conveyer (111) for depositing a polymeric composition on the substrate transported by the first conveyer (111);
a mixer (108) for providing the polymeric composition by mixing a resin composition without catalyst, particles being at least in parts heat-expandable and a catalyst, the mixer (108) being in fluid-connection with the coating head (109);
a first storage tank (101a) for the resin composition without catalyst, the first storage tank (101a) being in fluid-connection with the mixer (108);
a second storage tank (101b) for the catalyst, the second storage tank (101b) being in fluid-connection with the mixer (108);
a storage vessel (102) for the particles being at least in parts heat-expandable, the hopper (102) being in fluid-connection with the mixer (108);
a second conveyer (112) being arranged in parallel to the first conveyer (111) and at least in parts above the first conveyer (111);
a heat source being arranged along the first conveyor (111) and the second conveyor (112).
